(19) United States
(12) Patent Application Publication
(10) Pub. No.: US 2024/0166785 A1
(43) Pub. Date: May 23, 2024

(54) CATECHOL CONTAINING POLYMER EMULSIONS AND METHODS OF PREPARATION THEREOF

(71) Applicants: The University of Akron, Akron, OH (US); SWIMC LLC, Cleveland, OH (US)

(72) Inventors: Abraham JOY, Copley, OH (US); Amal NARAYANAN, Bedford Heights, OH (US); Kaushik MISHRA, Hudson, OH (US); Gamini SAMARANAYAKE, Cleveland, OH (US); Adam KOIS, Cleveland, OH (US)

(21) Appl. No.: 18/282,171

(22) PCT Filed: Mar. 16, 2022
(86) PCT No.: PCT/US2022/020513

§ 371 Date: Sep. 14, 2023

Related U.S. Application Data
(60) Provisional application No. 63/162,713, filed on Mar. 18, 2021.

(51) Int. Cl. C08F 220/18; C08F 2/22; C08F 218/08; C08F 230/08; C09D 133/08

(52) U.S. Cl. CPC C08F 220/18; C08F 2/22; C08F 218/08; C08F 230/085; C09D 133/08

(57) ABSTRACT

A water-borne emulsion polymer that comprises one or more dihydroxyphenyl groups pendent to a linear or branched backbone of the polymer as well as structural groups derived from alkyl(meth)acrylate, styrene, (meth)acrylic acid, vinyl acetate, vinyl esters, hydroxyalkyl (meth)acrylate, or combinations thereof. Also disclosed are coating compositions that include the emulsion polymer and methods of making the water-borne emulsion polymer.

### CROSS-REFERENCE TO RELATED APPLICATION

This application claims the benefit of U.S. Provisional Patent Application No. 63/162,713, filed Mar. 18, 2021. The entire contents of the aforementioned application are incorporated herein by reference.

### FIELD

This application generally relates to polymers prepared by emulsion polymerization and, in particular, emulsion polymers functionalized with one or more dihydroxyphenyl groups pendent to the backbone of the emulsion polymer.

### BACKGROUND

The coating industry serves a variety of diverse applications. Coatings often provide one or more features of protective, decorative, and/or functional elements in automobile, architectural, electronics, and/or consumer products to suggest but a few applications. Among other features, a coating may be used as a barrier to protect an underlying substrate from exposure to light, moisture, and/or fouling agents that can lead to corrosion, blooming, and/or deteriorate the performance of the substrate materials to suggest a few functionalities of conventional coatings. Coatings are applied to a wide range of substrates or materials such as metals, wood, cement, and/or plastics to suggest some common substrates. In this regard, coatings are often cost-effective, have ease of application to the variety of substrates with minimum surface preparation, should possess strong interfacial adhesion, and/or provide long-term resistance to moisture and corrosion. In many applications, there is often a challenge to maintain adhesion to certain substrates, particularly wet surfaces or applications where longer-term coating fidelity is required.

Compositions for coatings typically include a carrier liquid, various polymers, optionally one or more pigments, and/or other additives to provide the coating with various properties depending on the end use or application. The carrier liquid is a fluid component of the composition that serves to carry all of the other components. The carrier liquid usually evaporates as the coating forms a film and dries on a surface. In latex compositions, the carrier liquid is usually water. In oil-based compositions, the carrier liquid is usually an organic solvent.

Some marine organisms have been known to secrete a series of adhesive proteins rich in 3-4-dihydroxyphenylanine (DOPA), and it has been suggested that the catechol binding group of DOPA provides for strong adhesion to various surfaces.

Attempts have been made to incorporate catechol groups into the polymeric backbones of polymer components used in coating compositions. Such catechol groups may improve wet adhesion and/or other properties. Previous efforts incorporating catechol units into the polymeric backbone, however, have been limited to compositions using organic or solvent-based formulas. In waterborne or emulsion polymers, catechol insertion into water-borne formulas by emulsion polymerization is known to be problematic due to the oxidative nature of catechol units and their tendency to self-polymerize. Specifically, catechol structural units tend to self-polymerize in oxidative environments, such as the aqueous compositions used in emulsion polymerization, and have not been successfully incorporated into latex or emulsion polymers.

### SUMMARY

In one aspect, a waterborne coating composition prepared through emulsion polymerization is disclosed, the polymer comprising a backbone having one or more monomer units derived from ethylenically unsaturated monomers such as alkyl(meth)acrylate, styrene, (meth)acrylic acid, vinyl acetate, vinyl esters. hydroxyalkyl (meth)acrylate, or combinations thereof; one or more monomer units functionalized with a dihydroxyphenyl group pendent to the backbone of the polymer; and wherein the polymer is a water-based emulsion polymer.

Also disclosed is a coating comprising a polymer Wherein the polymer comprises: structural groups derived from one or more monomers selected from the group comprising alkyl(meth)acrylate, styrene, (meth)acrylic acid, vinyl acetate, vinyl esters, hydroxyalkyl (meth)acrylate, or combinations thereof; and dihydroxyphenyl groups pendent to a linear or branched backbone of the polymer; wherein the polymer has a number average molecular weight of about 50,000 to about 1,000,000 about a glass transition temperature of about −10° C. to about 110° C.

Methods of producing an emulsion polymer are also disclosed. Disclosed is a method for producing an emulsion polymer comprising polymerizing one or more ethylenically unsaturated monomers in an aqueous solution to form an emulsion polymer, wherein the emulsion polymer includes a protected residue of a catechol group; and reacting the emulsion polymer containing protected catechol groups with one or more reactants to deprotect the catechol group forming an emulsion polymer having one or more monomer units with the pendant group of structure A:

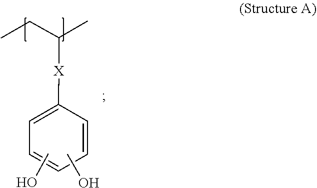

wherein X is a bivalent linking group including ester linkages, diester linkages, ether linkages, alkyl linkages, aryl linkages, amino linkages, amide linkages, or combinations thereof.

Also disclosed is a method for producing an emulsion polymer comprising reacting in an aqueous solution a silyl-protected compound comprising (meth)acrylate, styrene, or acetate monomer, or combinations thereof and disilyl ether phenolic groups, with a fluoride ion, acid, or base to yield a water-based emulsion polymer having dihydroxyphenyl groups pendent to a linear or branched backbone of the polymer; wherein the dihydroxyphenyl groups pendent to the linear or branched polymer backbone have the structure of Structure A:

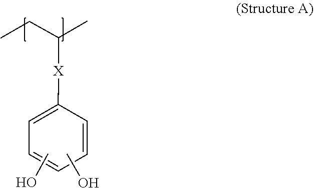

wherein X is a bivalent linking group including ester linkages, diester linkages, ether linkages, alkyl linkages, aryl linkages, amino linkages, amide linkages, or combinations thereof.

Also disclosed is a waterborne coating composition comprising an aqueous carrier and the water-based emulsion polymer described herein.

Also disclosed is a coated article comprising the coating composition applied to a substrate wherein the the substrate comprises coated or uncoated steel, aluminum, wood, drywall, glass, asphalt, concrete, or stone.

Also disclosed is a coating composition comprising a polymer wherein the polymer comprises structural groups derived from one or more monomers selected from the group comprising alkyl(meth)acrylate, styrene, (meth)acrylic acid, vinyl acetate, vinyl esters, hydroxyalkyl (meth)acrylate, or combinations thereof; and dihydroxyphenyl groups pendent to a linear or branched backbone of the polymer; and wherein the polymer has a number average molecular weight of about 50,000 to about 1,000,000 about a glass transition temperature of about −10° C. to about 110° C.

In other aspects or approaches, the emulsion polymer of the previous paragraphs may be combined with one or more optional features, either alone or in combination with any other optional feature. These optional features may include one or more of the following: wherein the emulsion polymer has a number average molecular weight of about 50,000 to about 1,000,000; and/or wherein the dihydroxyphenyl group is a phenyl group having hydroxyl groups that are bonded to adjacent carbon atoms on a benzene ring; and/or wherein the dihydroxyphenyl groups include one of a 2,3-dihydroxyphenyl group or a 3,4-dihydroxyphenyl group, or combinations thereof; and/or wherein the emulsion polymer includes about 0.1 to about 99 weight percent monomer units derived from vinyl monomers functionalized with a dihydroxyphenyl group, preferably about 1 to 90 weight percent monomer units derived from vinyl monomers functionalized with a dihydroxyphenyl group, more preferably about 2 to about 50 weight percent of monomer units functionalized with a dihydroxyphenyl group, and in other approaches, and even more preferably about 5 to about 20 weight percent of monomer units functionalized with a dihydroxyphenyl group; and/or wherein the polymer includes about 1 to about 95 weight percent monomer units derived from alkyl(meth)acrylate, about 10 to about 70 weight percent monomer units derived from styrene or alkyl styrene, and/or about 65 to about 90 weight percent monomer units derived from vinyl acetate; and/or wherein the polymer includes about 10 to about 50 weight percent monomer units derived from 2-ethyl hexyl acrylate; and/or wherein the polymer includes about 10 to about 90 weight percent monomer units derived from butyl acrylate, preferably about 30 to about 60 weight percent, even more preferably about 40 to about 55 weight percent; and/or wherein the polymer includes about 3 to about 70 weight percent monomer units derived from methyl methacrylate; and/or wherein the polymer includes about 20 to about 60 weight percent monomer units derived from styrene; and/or wherein the polymer includes about 50 to about 80 weight percent monomer units derived from vinyl acetate, preferably about 70 to about 80 weight percent monomer units derived from vinyl acetate.

The emulsion polymer also may be combined with any of the following optional features, either alone or in combination with any other optional feature: wherein the monomer units are derived from one or more of vinyl acetate, vinyl propionate, vinyl laurate, vinyl pivalate, vinyl nonanoate, vinyl decanoate, vinyl neodecanoate, vinyl butyrates, vinyl benzoates, vinyl isopropyl acetates, styrene, methyl styrene, chlorostyrene, vinyl toluene, vinyl naphthalene divinyl benzene, vinyl chloride, vinylidene chloride, methyl vinyl ether, isopropyl vinyl ether, n-butyl vinyl ether, isobutyl vinyl ether, or combinations thereof; and/or wherein the monomer units are derived from one or more of methyl (meth)acrylate, ethyl (meth)acrylate, butyl (meth)acrylate, propyl (meth)acrylate, 2-ethyl hexyl (meth)acrylate, cyclohexyl (meth)acrylate, decyl (meth)acrylate, isodecyl (meth)acrylate, benzyl (meth)acrylate, isobornyl (meth)acrylate, neopentyl (meth)acrylate, 1-adamatyl methacrylate, hydroxyethyl (meth)acrylates, hydroxypropyl (meth)acrylates, amino (meth)acrylates, (meth)acrylic acid, ethylacrylic acid, alpha-chloroacrylic acid, alpha-cycanoacrylic acid, crotonic acid, beta-acryloxy propionic acid, beta-styryl acrylic acid, or combinations thereof; and/or wherein the monomer units are derived from one or more of diacetone acrylamide, diacetone (meth)acrylamide, acetoacetoxyethyl (meth)acrylate, acrolein, methacrolein, vinylacetoacetate, crotonaldehyde, 4-vinylbenzaldehyde, vinyl alkyl ketones, acrylamidopivalaldehyde, methacrylamido pivalaldehyde, 3-acryl amidomethyl-anisaldehyde, diacetone acrylate, acetonyl acrylate, diacetone methacrylate, acetoacetoxyethylmethacrylate, 2-hydroxypropylacrylate acetylacetate, butanediolacrylate acetylacetate, or combinations thereof; and/or wherein the one or more monomer units functionalized with dihydroxyphenyl groups include a meth(acrylate) or vinyl acetate.

The emulsion polymer also may be combined with any of the following optional features, either alone or in combination with any other optional feature: wherein the emulsion polymer is stable without phase separation for at least about two weeks; and/or wherein the polymer has a glass transition temperature of about 30° C. to about 100° C.; and/or wherein the polymer has a glass transition temperature of about −2° C. to about 70° C.; and/or wherein the polymer has a glass transition temperature of about 19° C. to about 45° C.; and/or wherein the polymer has a glass transition temperature of about 10° C. to about 100° C.; and/or wherein the polymer has a glass transition temperature of about 50° C. to about 80° C.; and/or wherein the polymer has a glass transition temperature of about 60° C. to about 70° C.; and/or wherein the percent solids of the polymer based on the total weight of the emulsion is from about 30 percent to 70 percent, preferably from about 35 percent to about 65 percent, or even more preferably from about 45 percent to about 55 percent.

In other aspects or approaches, the coating composition of the previous paragraphs may be combined with one or more optional features, either alone or in combination with any other optional feature: wherein the coating composition further includes one or more of a pigment, a surfactant, extender particle, a defoamer, a biocide, or combinations thereof.

In other aspects or approaches, the emulsion polymer or coating composition of the previous paragraphs may be combined with one or more optional features, either alone or in combination with any other optional feature: wherein the polymer or waterborne coating composition has a pH of at least about 7, preferably at least about 7.5, or even more preferably at least about 8; and/or wherein the polymer or waterborne coating composition has less than about 200 g/L VOCs, less than about 100 g/L, less than about 50 g/L, less than about 10 g/L, less than about 5 g/l, or no VOCs; and/or wherein the polymer or waterborne coating composition has less than about 25 grams VOC per 100 grams polymer solids, no greater than 20 grams VOC per 100 grams polymer solids, no greater than 15 grams VOC per 100 grams polymer solids, no greater than 10 grams VOC per 100 grams polymer solids, no greater than 5 grams VOC per 100 grams polymer solids, or no greater than 2 grams VOC per 100 grams polymer solid.

In still other aspects or approaches, the coating composition of the previous paragraphs may be combined with one or more optional features, either alone or in combination with any other optional feature: wherein the composition has 40 to 60 weight percent solids; and/or wherein when dried as a film on a substrate, has a contrast ratio of about 0.95 to about 1.0; and/or wherein when dried as a film on a substrate, has a contrast ratio of about 0.75 to about 1.0; and/or wherein when dried as a film on a substrate, has a contrast ratio of about 0.0 to about 0.2.

In other aspects or approaches, the emulsion polymer or coating composition of the previous paragraphs may be combined with one or more optional features, either alone or in combination with any other optional feature: wherein the polymer or composition does not separate when stored for six months at about 70° C.

In other aspects or approaches, the method of the previous paragraphs may be combined with one or more optional features, either alone or in combination with any other optional feature: wherein the silyl-protected compound is derived at least in part from reaction of a dihydroxyphenyl alkanoic acid with a trialkyl silyl halide, silyl triflate, or silyl cyanide; and/or wherein the silyl-protected compound is further derived at least in part from reaction of an ethylenically unsaturated compound comprising (meth)acrylate, styrene, or acetate structural units; and/or wherein the fluoride ion is provided by a zinc compound; and/or wherein the fluoride ion is provided by a zinc tetrafluoroborate; and/or wherein the fluoride ion is provided by a tributyl ammonium fluoride; and/or wherein the fluoride ion is provided by a sodium or potassium compound; and/or wherein the trialkyl silyl compound is a halide salt of tert-butyldimethylsilane (TBDMS); and/or wherein the trialkyl silyl compound is a halide salt of trimethyl silane (TMS); and/or wherein the fluoride ion or acid is added to the monomer in an amount of at least 1, at least 2, at least 3, or at least 5 equivalents of fluoride per catechol group present in the aqueous solution

In other aspects or approaches, the emulsion polymer, coating composition, method, or coating of the previous paragraphs may be combined with one or more optional features, either alone or in combination with any other optional feature: wherein the polymer includes monomer units derived from (meth)acrylate groups; and/or wherein the polymer includes monomer units derived from styrene groups or methyl styrene groups.

In other aspects or approaches, the emulsion polymer, coating composition, method, or coating of the previous paragraphs may be combined with one or more optional features, either alone or in combination with any other optional feature: wherein the polymer includes monomer units derived from alkyl (meth)acrylate groups having the structure of Formula B:

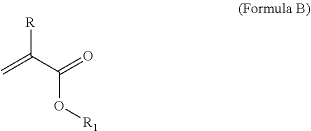

wherein R is hydrogen or a methyl group and R₁ is a linear or branched C1 to C10 group.

In other aspects or approaches, the emulsion polymer, coating composition, method, or coating of the previous paragraphs may be combined with one or more optional features, either alone or in combination with any other optional feature: wherein the emulsion polymer includes about 3 to about 20, more preferably about 6 to about 15, and even more preferably 9 to about 12 weight percent dihydroxyphenyl groups based on the weight of the monomers used to derive the polymer; and/or wherein the emulsion polymer includes a dihydroxyphenyl functionality of at least about 0.005 preferably about 0.01 to about 0.038, and more preferably about 0.015 to about 0.025 moles per 100 grams polymer

The foregoing summary of the invention is not intended to describe each and every disclosed embodiment or every implementation of the present disclosure. The description that follows more particularly exemplifies illustrative embodiments.

### FIGURES

FIG. 1 is a ¹H NMR spectra of an exemplary protected catechol monomer in CDCl₃;

FIG. 2 is a ¹H NMR spectra of an exemplary emulsion polymer including protected catechol groups in CDCl₃; and

FIG. 3 is a ¹H NMR spectra of an exemplary emulsion polymer after deprotection and having catechol groups pendant to a polymer backbone.

### DETAILED DESCRIPTION

The present disclosure provides an emulsion polymer and a waterborne coating composition including the emulsion polymer wherein the emulsion polymer includes catechol-grafted groups. The present disclosure also provides for polymers obtained from an emulsion polymerization process that first protects the catechol groups or moieties grafted on the polymer during the polymerization and then deprotects the catechol groups or moieties forming a stable emulsion polymer having functional grafted catechol groups. In one approach, for instance, the emulsion polymerization process includes select hydrophobic protecting groups for the catechol moieties to protect the catechol groups during emulsion polymerization combined with a compatible deprotection reaction scheme to expose and/or form the catechol-grafted emulsion polymers in the final product. In other approaches, the polymers herein are prepared through emulsion polymerization and include, in some embodiments, a backbone having one or more monomer units derived from ethylenically unsaturated monomers including, but not limited to, alkyl(meth)acrylate, styrene, (meth)acrylic acid, vinyl acetate, vinyl esters, hydroxyalkyl (meth)acrylate, or combinations thereof. One or more of the monomer units on the emulsion polymer, such as an alkyl(meth)acrylate monomer unit but may be any of the other units, is functionalized with a dihydroxyphenyl group (i.e., catechol group) pendent to the backbone of the polymer. The resultant polymer is a water-based emulsion polymer having the pendant catechol groups and, in some approaches, an emulsion polymer having a number average molecular weight of at least about 50,000, at least about 100,000, at least about 250000, at least about 500,000 to about 1,000,000 or less, about 800,000 or :less, about 750,000 or less, or about 600,000 or :less. As used herein, the molecular weight is determined by gel permeation chromatography (GPC) using commercially available polystyrene standards. The emulsion polymer may also have a glass transition temperature of about −20° C. to about 100° C. (or other ranges as discussed further below).

As explained in the Background, previous efforts incorporating catechol units into a polymeric backbone were limited to solvent-based polymers or organic solution-based compositions. Due to the oxidative nature of catechol units and their tendency to self-polymerize in aqueous environments, insertion into waterborne compositions by emulsion polymerization was not previously possible. The present disclosure, on the other hand, overcomes such prior obstacles through use of select hydrophobic or organic/inorganic-based protection groups on the catechol moieties during the emulsion polymerization phases. Without wishing to be limited by theory, it is believed that the select organic/inorganic-based protecting groups protect or shield the pendant catechol moieties from high pH and oxidative conditions present during the emulsion polymerization phase. These organic/inorganic-based protecting groups are then removed after polymerization is completed to subsequently expose the pendant and intact catechol moieties in the resultant emulsion polymer and to provide its desired functionality including, but not limited to, enhancement of wet-adhesion benefits in the context of an emulsion or latex polymer.

In approaches, the pendant catechol groups on the emulsion or latex polymer are provided by dihydroxyphenol groups pendant to the main polymer backbone. Each catechol or dihydroxyphenyl group is a phenyl group having two hydroxyl-groups that are preferably bonded to adjacent carbon atoms on a benzene ring such as 2,3-dihydroxyphenyl group or 3,4-dihydroxyphenyl group or combinations thereof as represented by Structure A below:

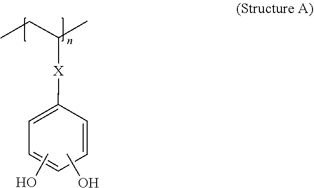

wherein X is a bivalent linking group between the dihydroxyphenyl group and main polymer backbone including, but not limited to, ester linkages, diester linkages, ether linkages, alkyl linkages, aryl linkages, amino linkages, amide linkages, or various combinations thereof, and n is an integer sufficient to form the desired molecular weights (in combination with any other monomer units) as described herein. Each repeating units represented by structure A may be formed by any of the monomer units are described herein. Any polymer herein may also include combinations of catechol-functionalized monomer units and non-catechol-functionalized monomer units.

In approaches or embodiments, the emulsions polymers herein may include at least about 0.1 weight percent, at least about 1 weight percent, at least 2 percent, at least 3 weight percent, or preferably at least about 5 weight percent, or more preferably, at least about 20 weight percent of structural units derived from vinyl monomers (or other monomers) functionalized with the above dihydroxyphenyl groups. In other approaches, emulsion polymers herein may include at most 99 weight percent, at most about 90 weight percent of monomer units functionalized with the above dihydroxyphenyl groups, and in yet further approaches, at most about 50, or at most about 20 weight percent, or at most 15 weight percent, or at most 10 weight percent of structural units derived from vinyl monomers (or other monomers) functionalized with the above dihydroxyphenyl groups.

The waterborne coating compositions herein include one or more binder or film-forming polymer(s) wherein at least a portion of the binder or polymer is functionalized with the catechol groups. In one approach or embodiment, the polymer includes one or more monomer units polymerized together via emulsion polymerization techniques (discussed more below). The binder or emulsion polymers herein have a carbon chain with the largest number of carbon atoms, which may be designated as a main carbon chain or backbone of the polymer. The main chain or backbone typically includes the carbon atoms derived from the carbon-carbon double bonds in the various monomers participating in the polymerization reactions, and/or any additional carbon atoms from monomer molecules and/or molecules in the co-monomers used in the polymerizations.

In one embodiment or approach, the emulsion polymers herein may be acrylic polymers or copolymers prepared from ethylenically unsaturated or vinyl monomers such as one or more of alkyl (meth)acrylate monomer units, vinyl acetate monomer units, styrene monomer units, (meth)acrylic acid, vinyl esters, hydroxyalkyl (meth)acrylate, ketone-functional vinyl monomer units, and the like, or combinations thereof. In some approaches, the emulsion or binder polymer may have a glass transition temperature (as discussed more below) of about −20° C. to about 100° C. (in other approaches, about 0° C. to about 100° C., about 10° C. to about 90° C., about 20° C. to about 80° C., about 20° C. to about 70° C., about 20° C. to about 30° C., about 10° C. to about 30° C., about 10° C. to about 20° C., or about 10° C. to about 15° C.) In other approaches, the emulsion polymer may have a glass transition temperature of about 30° C. to about 100° C., about −20° C. to about 70° C., about −2° C. to about 70° C., about 19° C. to about 45° C., about 10° C.′ to about 100° C., about 50° C. to about 80° C., or about 60° C. to about 70° C.; depending on the end use or application of the polymers herein as discussed more below.

In embodiments, the emulsion polymers may have the molecular weights as described above and may be used in waterborne compositions having a percent solids of the polymer (based on the total weight of the emulsion or composition) of about 30 weight percent to 70 weight percent (preferably from about 35 weight percent to about 65 weight percent, or even more preferably from about 45 weight percent to about 55 weight percent.)

In some approaches, the emulsion polymers herein may be an acrylic, styrene acrylic, or vinyl acrylic polymer or copolymer and/or blends thereof including ethylenically unsaturated monomers with at least carboxylic acid, alkyl acrylate, alkyl methacrylate, or acetate moieties, monomer units, or repeating units in the polymer. The polymer may include as polymerizable units in a polymer backbone vinyl monomers and acrylic monomers such as at least vinyl acetate, alkyl acrylate, alkyl methacrylate, acrylic, styrene acrylic, and combinations thereof. Alkyl groups of the monomers may have linear or branched chain lengths from C1 to C8 and, in some approaches, are ethyl, propyl, isopropyl, butyl, ethyl hexyl, and the like side groups.

In some approaches, vinyl monomers are selected from the group consisting of vinyl esters, vinyl aromatic hydrocarbons, vinyl aliphatic hydrocarbons, vinyl alkyl ethers and mixtures thereof. Examples of vinyl esters that may be used include vinyl acetate, vinyl propionate, vinyl laurate, vinyl pivalate, vinyl nonanoate, vinyl decanoate, vinyl neodecanoate, vinyl butyrates, vinyl benzoates, and vinyl isopropyl acetates. Examples of vinyl aromatic hydrocarbons that may be used include styrene, methyl styrenes and other lower alkyl styrenes, chlorostyrene, vinyl toluene, vinyl naphthalene and divinyl benzene. Examples of vinyl aliphatic hydrocarbons that may be used include vinyl chloride and vinylidene chloride as well as alpha olefins such as ethylene, propylene, isobutylene, as well as conjugated diener such as 1,3 butadiene, methyl-2-butadiene, 1,3-piperylene, 2,3-dimethyl butadiene, isoprene, cyclohexene, cyclopentadiene, and dicyclopentadiene. Examples of vinyl alkyl ethers that may be used include methyl vinyl ether, isopropyl vinyl ether, n-butyl vinyl ether, and isobutyl vinyl ether.

Acrylic monomers suitable for use in the emulsion polymers herein may include any compounds having acrylic functionality. Suitable acrylic monomers are selected from the group consisting of alkyl (meth)acrylates, acrylic acids, as well as aromatic derivatives of (meth)acrylic acid, acrylamides, acrylonitrile, or combinations thereof. Typically, the alkyl (meth)acrylate monomers (also referred to herein as “alkyl esters of ((meth)acrylic acid”) will have an alkyl ester portion containing from 1 to 12, in some approaches, about 1 to 8, in yet other approaches, about 1 to 6, and in yet further approaches, 1 to 4, carbon atoms per molecule.

Suitable acrylic monomers in the emulsion polymer may include, for example, methyl (meth)acrylate, ethyl (meth)acrylate, butyl (meth)acrylate, propyl (meth)acrylate, 2-ethyl hexyl (meth)acrylate, cyclohexyl (meth)acrylate, decyl (meth)acrylate, isodecyl (meth)acrylate, benzyl (meth)acrylate, isobornyl (meth)acrylate, neopentyl (meth)acrylate, 1-adamatyl methacrylate and various reaction products such as butyl, phenyl, and cresyl glycidyl ethers reacted with (meth)acrylic acid, hydroxyl alkyl (meth)acrylates, such as hydroxyethyl and hydroxypropyl (meth)acrylates, amino (meth)acrylates, as well as acrylic acids such as (meth)acrylic acid, ethacrylic acid, alpha-chloroamilic acid, alpha-cycanoacrylic acid, crotonic acid, beta-acryloxy propionic acid, and beta-styryl acrylic acid.

In some approaches, the emulsion polymers herein may include monomer units derived from alkyl (meth)acrylate or alkyl (meth)acrylate groups having the structure of Formula B:

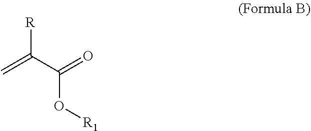

wherein R is hydrogen or a methyl group and R₁ is hydrogen, a linear or branched C1 to C10 group, or any of the X bivalent linking groups as discussed above (if the structural unit of Formula B is functionalized with catechol). The structure of Formula B may also be functionalized with any embodiment of the catechol groups herein.

In approaches, the emulsion polymers herein may include about 1 to about 97 weight percent monomer units derived from alkyl(meth)acrylate monomers, in other approaches, about 50 to about 97, in other approaches about 80 to about 97, or in further approaches, about 90 to about 94 weight percent monomer units derived from alkyl(meth)acrylate); about 10 to about 70 weight percent monomer units derived from styrene or alkyl styrene monomers (in other approaches, about 20 to about 50 weight percent monomer units derived from styrene or alkyl styrene, or in further approaches, about 30 to about 40 weight percent monomer units derived from styrene or alkyl styrene); and/or about 15 to about 90 weight percent monomer units derived from vinyl acetate monomers (in other approaches, about 35 to about 65 weight percent monomer units derived from vinyl acetate, or in further approaches, about 40 to about 60 weight percent monomer units derived from vinyl acetate).

In some embodiments, the emulsion polymer may include monomer units derived from 2-ethyl hexyl (meth)acrylate, butyl (meth)acrylate, methyl (meth)acrylate, styrene, and/or vinyl acetate. In such embodiments, the emulsion polymer may include about 10 to about 50 weight percent monomer units derived from 2-ethyl hexyl (meth)acrylate (in other approaches, about 10 to about 25 weight percent monomer units derived from 2-ethyl hexyl (meth)acrylate, or in further approaches, about 15 to about 20 weight percent monomer units derived from 2-ethyl hexyl (meth)acrylate). The emulsion polymer may include about 10 to about 90 weight percent monomer units derived from butyl (meth)acrylate (in some approaches, about 30 to about 60 weight percent monomer units from butyl (meth)acrylate, and in other approaches, about 40 to about 55 weight percent of monomer units from butyl (meth)acrylate). The emulsion polymer may include about 3 to about 70 weight percent monomer units derived from methyl (meth)acrylate (in other approaches, about 15 to about 40 weight percent monomer units derived from methyl (meth)acrylate, or in further approaches, about 20 to about 35 weight percent monomer units derived from methyl (meth)acrylate). The emulsion polymer may include about 10 to about 60 weight percent monomer units derived from styrene (in other approaches, about 15 to about 30 weight percent monomer units derived from styrene, or in further approaches, about 15 to about 20 weight percent monomer units derived from styrene). The emulsion polymer may also include about 50 to about 80 weight percent monomer units derived from vinyl acetate (in other approaches, about 70 to about 80 weight percent of monomer units derived from vinyl acetate, and in yet other approaches, about 40 to about 60 weight percent of monomer units derived from vinyl acetate).

Any of the monomer units described herein may be functionalized with the catechol groups and having the bivalent linking group X mentioned above between the polymeric backbone and the aromatic groups of the catechol units. As noted above, the linking group may be ester linkages, diester linkages, ether linkages, alkyl linkages, aryl linkages, amino linkages, amide linkages, or various combinations thereof. Preferably, one or more of the monomer units functionalized with the pendent catechol groups or the dihydroxyphenyl groups includes a (meth)acrylate or vinyl acetate monomer unit. In such content, suitable linking X units may include ester or diester groups such as —R₂—C(O)O—R₃-— moieties wherein each of R₂ and R₃ is independently a C1 to C10 alkyl group and preferably a C1 to C3 alkyl group.

The polymers herein may also include optional monomer units, such as ketone-functional vinyl monomer units. In some approaches, these monomer units may be derived from diacetone acrylamide, diacetone (meth)acrylamide, acetoacetoxyethyl (meth)acrylate, acrolein, methacrolein, vinylacetoacetate, crotonaldehyde, 4-vinylbenzaldehyde, vinyl alkyl ketones, acrylamidopivalaldehyde, methacrylamidopivalaldehyde, 3-acryl amidomethyl-anisaldehyde, diacetone acrylate, acetonyl acrylate, diacetone methacrylate, acetoacetoxyethyl methacrylate, 2-hydroxypropylacrylate acetylacetate, and butanediolacrylate acetylacetate and the like, and combinations thereof. In some approaches, the emulsion polymers herein may include about 0 to about 20 weight percent of the optional ketone-functional monomer units, and in other approaches, about 0 to about 12 weight percent, and in yet other approaches, about 1 to about 16 weight percent or 2 to about 12 weight percent as a percentage of the acrylic phase.

The emulsion polymers herein may also include other optional monomers and monomer units polymerized into the polymer backbone as needed for a particular application. For instance, the copolymer may further include ureido monomers, amino monomers, sulfonate monomers or surfactants, silane monomers, phosphate monomers or surfactants, carboxyl monomers or surfactants, and combinations thereof. In some approaches, the copolymer may further include vinyl monomers such as allyl imidazolidinone, allyl acetoacetates, allyl epoxies, epoxy acrylates, carbonyl monomers, other sulfonates, other phosphonates, vinyl phosphonate, allyl hydroxypopyl sodium sulfonate, allyloxy hydroxypropyl sodium sulfonate, and combinations thereof as needed for a particular application. In some approaches, for instance, the other monomers may each be present in the emulsion polymers in amounts up to about 10 weight percent, and in other approaches, about 0.1 to about 5 weight percent, in other approaches, about 0.5 to about 2 weight percent, but the amounts may vary depending on the particular application. In other approaches, the other or additional monomers may each be included in the polymer backbone in amounts less than about 1 weight percent.

The waterborne coating compositions of the present disclosure may also include optional opacifying pigments. If included, suitable pigment particles and/or inorganic particles used in the polymer compositions or complexes or the water-borne coating composition of the present disclosure may be titanium dioxide (TiO₂) zinc oxide (ZnO₂), calcium carbonate (CaCO₃), talc, clay materials, aluminum oxide, silicon dioxide, magnesium oxide, zinc sulfate, combinations thereof, or other known pigment or inorganic particles suitable for paints and other coatings. In some approaches, the pigment or inorganic particle is titanium dioxide, which may comprise anatase titanium dioxide or rutile titanium dioxide, or a mixture of the two. In other approaches, the pigment or inorganic particle comprises rutile titanium dioxide, to the exclusion of anatase titanium dioxide. In some approaches, the ruffle titanium dioxide is surface treated with an inorganic oxide, such as silica (SiO₂). Generally, the opacifying pigments, such as titanium dioxide, have a particle size less than a micron, such as about 0.2 to about 0.3 microns in diameter and provided in powder form, or in an aqueous slurry. An example of a titanium dioxide that is suitable for use is Ti-Pure® R-706, which is commercially available from E.I. du Pont de Nemours and Company. Ti-Pure® R-706 titanium dioxide is a rutile titanium dioxide that is surface treated with silica. In some approaches and if included in the compositions, the waterborne compositions herein may include about 10 to about 30 weight percent of titanium dioxide, about 15 to about 20 weight percent, or about 18 to about 25 weight percent of titanium dioxide.

As discussed above, the water-borne coating compositions herein may optionally include inorganic or mineral extenders and/or matting agents such as calcium carbonate, silicates, diatomaceous earth, clay, asbestine, barytes, silica, mica, and microspheres (glass, ceramic, or polymeric, and can be filled or hollow). Such mineral extenders or matting agents have particle sizes of about 1 micron or larger. In some approaches and if included in the compositions, the waterborne compositions herein may include about 0 to about 35 weight percent of titanium dioxide, about 0 to about 30 weight percent, or about 5 to about 20 weight percent of inorganic or mineral extenders.

The waterborne coating compositions of the present disclosure may also include other optional additives as needed for typical applications. For instance, the waterborne coating composition of the present disclosure may be produced using techniques known to those skilled in the art of manufacturing paint or coatings. In addition to the catechol-functionalized emulsion polymers herein, coating compositions herein may also include other polymers, binder polymers, opacifying pigments, extender pigments, surfactants, thickeners, coalescing aids, biocides, anti-foaming or defoamer agents, freeze-thaw additives, and the like. It should also be appreciated that in addition to the opacifying pigment, small amounts of other pigments or colorants may be used to provide desired coloration or to confer other optical effects.

### Emulsion Polymerization

Preferably the polymers of the present disclosure may be formed by conventional or free radical emulsion polymerization by using techniques known to those of ordinary skill. By one approach, a reactor is charged with an aqueous medium, any stabilizers and surfactants and/or initiators. Separately, a monomer pre-emulsion mixture may be prepared by dispersing the various polymerizable units and monomers discussed above in an aqueous medium along with stabilizers surfactants, defoamers, and the like. A small amount of the monomer pre-emulsion may be removed for seeding. Next, a redox oxidizer solution may be prepared by dissolving, for instance, sodium persulfate or tert-butyl hydroperoxide in water. A small amount of the oxidizer may also be removed for seeding. A reducer solution may prepared, for instance, dissolving sodium meta bisulfite and/or a sulfuric acid derivative (for example, Bruggolite FF6) in water. A small amount of the reducer solution may also be removed for seeding. Next, a chase oxidizer solution and chase reducer solution may be prepared. The chase oxidizer solution may be prepared by, for instance, t-butyl hydroperoxide in water and the chase reducer solution may prepared by combining for instance, sodium meta bisulfite and/or a sulfuric acid derivative in water.

After a reaction hold period, the reactor may be cooled to a desired temperature, in some instances about 60° C. or below, whereupon the chase oxidizer and chase reducer solutions are fed to the reactor over a desired time period, which may be about 30 minutes to about 60 minutes. The reactor is wain held for a desired time period, such as for about 15 minutes to about 60 minutes. the reactor is then cooled further and any post addition ingredients, such as preservatives, defoamers, pH adjusters, and the like, may be added. the resultant polymer may be filtered if needed.

In the polymerizations herein, the initiator may be used in an amount sufficient to catalyze the polymerization reactions. This amount will typically vary from about 0.01 to 3 weight percent based on the weight of monomers charged. However, the concentration of the initiator is preferably from about 0.05 to about 2 weight percent and, more preferably, from about 0.1 to about 1 weight percent of the monomers charged. The particular amount used in any instance will depend upon the specific monomer mixture undergoing reaction and the specific initiator employed, which details are known to those skilled in the art. Suitable initiators that may be used in the polymerization of the core-shell polymer and in the polymerization of the primary binder polymer include, but are not limited to, hydrogen peroxide, peracetic acid, t-butyl hydroperoxide, di-t-butyl hydroperoxide, dibenzoyl peroxide, benzoyl hydroperoxide, 2,4-dicholorbenzoyl peroxide, 2,5-dimethyl-2,5-bis(hydroperoxy) hexane, perbenzoic acid, t-butyl peroxypivalate, t-butyl peracetate, dilauroyl peroxide, dicapryloyl peroxide, distearoyl peroxide, dibenzoyl peroxide, diisopropyl peroxydicarbonate, di decyl peroxydicarbonate, dicicosyl peroxydicarbonate, di-t-butyl perbenzoate, 2,2′-azobis-2,4-dimethylvaleronitrile, ammonium persulfate, potassium persulfate, sodium persulfate, sodium perphosphate, azobisisobutyronitrile, as well as any of the other known initiators. Also useful are the redox catalyst systems such as sodium persulfate-sodium formaldehyde sulfoxylate, cumene hydroperoxide-sodium metabisulfite, hydrogen peroxide-ascorbic acid, and other known redox systems. Moreover, as known by those skilled in the art, traces of metal ions can be added as activators to improve the rate of polymerization, if desired.

The water-borne coating composition of the present invention using the polymers herein may be produced using conventional latex paint forming techniques known to those skilled in the art of manufacturing paint. In addition to the catechol-functionalized polymer(s) described above, an optional dispersant latex, and optional extender, and an optional thickener, the water-borne coating composition may contain conventional additives such as coalescing aids, biocides, anti-foaming agents, freeze-thaw additives, rheology modifiers, surfactants, preservatives, and the like and combinations thereof. It should also be appreciated that in addition to the pigment and the extender, small amounts of other pigments or colorants may be used to provide desired coloration or to confer other optical effects.

In embodiments, the emulsion polymer and/or any waterborne coating composition including the emulsion polymers herein may have a pH suitable for emulsion polymerization. For instance, the polymer and/or compositions may have pH of at least about 7, preferably at least about 7.5, or even more preferably at least about 8. In other approaches, the pH may be about 9,5 or less, about 8 or less, or about 7.5 or less.

In other embodiments or approaches, the emulsion polymer or waterborne coating compositions including the catechol-functionalized emulsion polymers have low amounts of volatile organic components (VC)Cs). In approaches, the polymer or waterborne coating compositions including the polymers herein have less than about 200 g/L VOCs, less than about 100 g/L, less than about 50 g/Lt, less than about 10 g/L, less than about 5 g/L, or no VOCs. In other approaches, the emulsion polymer or waterborne coating composition including the emulsion polymers may have less than about 25 grams VOC per 100 grams polymer solids, no greater than 20 grams VOC per 100 grams polymer solids, no greater than 15 grams VOC per 100 grams polymer solids, no greater than 10 grams \IOC per 100 grams polymer solids, no greater than 5 grams VOC per 100 grams polymer solids, or no greater than 2 grams VOC per 100 grams polymer solids.

In other embodiments or approaches, the emulsion polymers or waterborne coating compositions including the catechol-functionalized emulsions polymers herein, when dried as a film on a substrate, exhibit a contrast ratio (as described below) of about 0.95 to about 1,0, or about 0.75 to about 1.0, or even about 0.0 to about 0.2.

In yet other embodiments or approaches, the emulsion polymers or waterborne coating compositions including the catechol-functionalized emulsions polymers herein remain stable as an aqueous emulsion. For example, the emulsion polymers or waterborne coating compositions including the catechol-functionalized emulsions polymers do not separate into phases when stored for at least six months at about 70° C.

In yet other embodiments, the emulsion polymer disclosed herein may include about 3 to about 20, more preferably about 6 to about 15, and even more preferably about 9 to about 12 weight percent dihydroxyphenyl groups based on the weight of the monomers used to derive the polymer. In yet other embodiments, the emulsion polymer may include a dihydroxyphenyl functionality of at least about 0.005, preferably about 0.01 to about 0.038, and more preferably, about 0.015 to about 0.025 moles of dihydroxyphenyl group per about 100 grams polymer.

Protection and Deprotection of the Catechol Functionality: The catechol-functionalized polymers herein are prepared using a unique protection and deprotection reaction scheme combined with emulsion polymerization techniques and conditions. In some approaches or embodiments, the catechol-functionalized polymers herein are prepared by polymerizing one or more ethylenically unsaturated monomers in an aqueous solution to form an emulsion polymer (as discussed above), wherein the emulsion polymer includes one or more monomer units thereof having a protected residue of a catechol group pendant to a polymer backbone thereof during the emulsion polymerization. Then, after emulsion polymerization is completed to the desired molecular weights, the emulsion polymer containing the protected catechol groups is then deprotected by reaction with one or more select reactants to deprotect and expose the catechol group forming an emulsion polymer the having one or more monomer units with the functionalized or exposed pendant group of structure A:

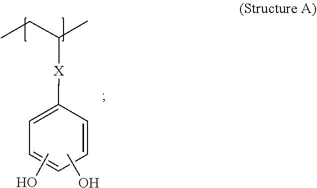

and
wherein X, as already described above, is a bivalent linking group including ester linkages, diester linkages, ether linkages, alkyl linkages, aryl linkages, amino linkages, amide linkages, or various combinations thereof, or combinations thereof.

In approaches or embodiments, the one or more monomer units having a protected residue of a catechol group is prepared by reacting the selected catechol-functionalized reactant with a suitable protecting moiety providing, without wishing to be limited by theory, suitable levels of hydrophobicity to the catechol-functionalized reactant or monomer. In embodiments, the protecting moiety may derived from an organic/inorganic reactant including trialkyl silyl halide, silyl triflate, silyl cyanide, or, in some approaches, a halide salt of tert-butyldimethylsilane (TBDMS). Once protected, and again not wishing to be limited by theory, the protected catechol-functionalized reactant or monomer may have a hydrophobicity as evidenced by a cLogP value of 5 or higher, 6 or higher, 7 or higher, or 10 or less (see Ahn Kolbe et al., ACs Applied Materials & Interfaces, 2018, 10, 1520.)

The catechol-functionalized monomer units with the protected catechol-groups may be prepared in a step-wise manner, for instance, by first reacting a catechol-providing base-reactant with the selected protecting group (such as the trialkyl silyl halide, silyl triflate, or silyl cyanide) under conditions to form a silyl-ether bond. The catechol-providing base-reactant may be a dihydroxyphenyl alkanoic acid, such as dihydroxyphenyl propanoic acid or a beta-hydroxylated derivative of phenylalanine such as dihydroxyphenylalanine. Other suitable catechol-providing base reactants may be any form of ethylenically unsaturated modify dihydroxyphenyl alkyloxy or alkyl amino residues, dihydroxyphenyl naphthalene alkanoic acid, dihydroxyaniline, dopamine, reagants derived therefrom, or combinations thereof. The base reactant may then be combined with the selected protecting group discussed above under conditions to form the silyl ether bonds. Such intermediate product may then be reacted with an ethylenically unsaturated compound comprising (meth)acrylate, styrene, or acetate structural units. Suitable ethylenically unsaturated compounds may include HEMA or 2-hydroxyethyl (meth)acrylate, which is a hydroxyester (meth)acrylate having the structure shown below:

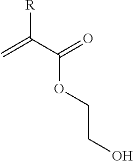

where R is a hydrogen if the monomer or repeating unit thereof is an acrylate and CH₃ if the monomer or repeating unit thereof is a methacrylate. An exemplary reaction scheme to form an ethylenically unsaturated compound or monomer having protected catechol groups (i.e., Compound M below) may be shown below in Reaction Scheme I:

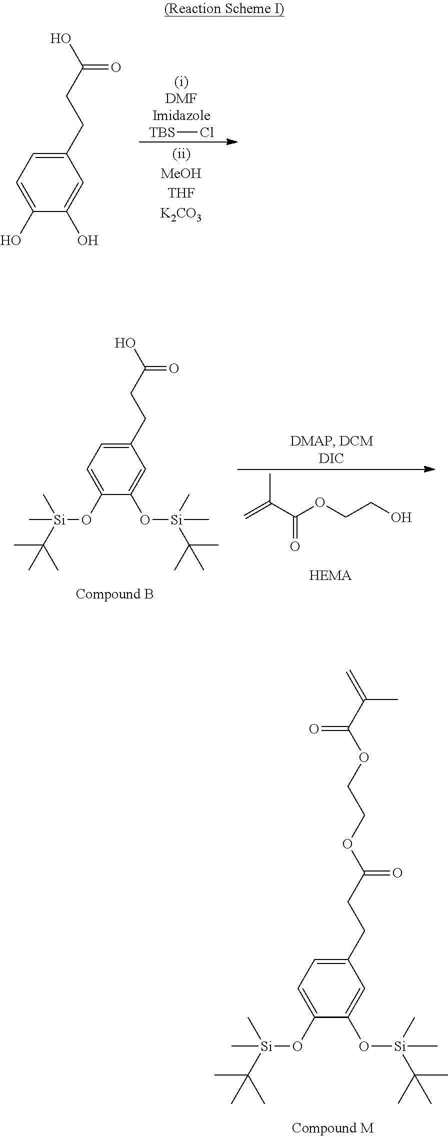

Compound M herein is an exemplary reactant suitable for the emulsion polymerizations as described herein.

The protected monomer or reactant is then polymerized as described above using emulsion polymerization techniques and conditions. Emulsion polymerization may occur to a desired number average molecular weight (as described above) and at a pH of at least about 7, preferably at least about 7.5, or even more preferably at least about 8.

After polymerization, the protected catechol groups within the formed emulsion polymer are then deprotected to expose the catechol functionality. Deprotection occurs by post-reacting or post-modifying the formed emulsion polymer to remove the protection groups and reform or expose the catechol groups. Deprotection occurs by reacting the polymer with a suitable deprotection agent, such as a fluoride ion source, an acid, or a base to remove the protecting group and expose the catechol groups. Suitable deprotection agents may be provided by a zinc compound such as zinc tetrafluoroborate (ZnBF₄) or other fluoride-based compounds such as tributyl ammonium fluoride, fluoroborate (BF₄⁻) salts such as sodium fluoroborate (NaBF₄) or lithium fluoroborate (LiBF₄), other acidic reagents such as hydrogen chloride, trifluoroacetic acid, acetic acid, or 1,1,3,3-tetramethylguanidine may also be used as needed for a particular use and/or application. Preferably, the deprotection agent is a fluoride ion source or compound and, most preferably, provided by the zinc tetrafluoroborate. In some approaches, the fluoride ion is added to the mixture in an amount of at least 1, at least 2, at least 3, or at least 5 equivalents of fluoride per catechol group present in the aqueous solution.

In approaches, about 1.2 to about 1,5 molar equivalents of the deprotection agent (such as zinc tetrafluoroborate) to the molar amounts of the protected catechol present in the polymer is added to the protected emulsion polymer to sufficiently deprotect the catechol moieties on the emulsion polymer, and in other approaches, about 1.25 to about 1.45 molar equivalents, and in yet further approaches, about 1.3 to about 1.4 molar equivalents of deprotection agent to the molar amounts of the protected catechol present in the polymer is added. The post-modification of the polymers for the deprotection may occur at about 60° C. to about 75° C. for about 1 to about 96 hours.

The emulsion polymers functionalized with the catechol groups disclosed herein and as synthesized using the unique protection and deprotection reaction schemes can be used as-produced in a wide variety of coating applications including automotive, architectural, electronic, marine, industrial, adhesive, and/or combinations thereof. The catechol group may be used in primer or base layers and/or in decorative layers. Catechol functionality of the emulsion polymers may aid in adhesion to low surface tension substrates, such as IPO (thermoplastic polyolefin) or Teflon for instance. Also, the hydroxyl groups of catechol functionality of the various polymers can be utilized for conjugating or linking to yet other functional groups to extend the applications to other applications including medical, engineering, or biomedical coatings and/or adhesives. For example, the catechol hydroxyl groups can be modified with ligands, therapeutics, peptides or growth factors to enhance the functionality and end use. The emulsion polymers with catechol groups disclosed herein may be used to provide coating adhesion through contaminants such as water, oil, solvents, other organic molecules, or through other polymeric materials such as residues of prior coating compositions.

The emulsion polymers disclosed herein also may be used in medically-compatible compositions. Since medically-compatible compositions come into contact with blood, body fluids, and/or biological tissue, medically-compatible compositions should have suitable compatibility with blood, body fluids, and/or biological tissue. Medically-compatible compositions may include the polymers herein along with one or more medical compatibilization components. Medical compatibilization components may include hydrophilicity agents and antithrombotic agents. Medically-compatible compositions may be utilized with surgical tools, membranes, catheters, blood vessels, organs, artificial blood vessels, and/or artificial organs. Medically-compatible compositions may be applied directly or indirectly on films, sheets, rods, tubes, fibers, and/or fabrics used in medical applications, or may be utilized with implantable devices and/or surgical devices.

### Glossary of Terms

Additives refer to a general category of components or other raw materials that may be added to the coatings herein to promote various properties. Examples include, but are not limited to, surfactants, defoamers, biocides, mildewcides, algaecides, thickeners, anti-settling agents, pH buffers, corrosion inhibitors, driers, and/or anti-skinning agents.

Glass Transition Temperature or Tg generally refers to a temperature region Where an amorphous polymer transitions from a hard, glassy material to a softer, rubbery material. Typically, this transition is reversible. Tg is measured by differential scanning calorimetry (DSC) and/or dynamic mechanical analysis (DMA), such as with a TA Instruments Q200 differential scanning calorimeter or the like instrument. To measure Tg using DSC, a sample deposited on a panel first is baked in a Fisher ISOTEMP™ electric oven for 20 minutes at 149° C. (300° F.) to remove volatile materials. After cooling to room temperature, samples are scraped from the panels, weighed into standard sample pans and analyzed using the standard DSC heat-cool-heat method. The samples were equilibrated at −60° C., then heated at 20° C. per minute to 200° C., cooled to −60° C., and the heated again at 20° C. per minute to 200° C. Glass transitions are calculated from the thermogram of the last heat cycle. The glass transitions are measured at the inflection point of the transition. Preferably, Tg is measured through DSC.

If used herein, Volatile Organic Compound or VOC generally refers to organic compounds that have a high vapor pressure at room temperature. In many cases, VOCs are compounds with a vapor pressure of greater than about 0.1 mm of Hg. VOC as reported herein is measured according to ASTM D2369-90 and is the weight of the VOC per volume of the coating solids in grams/L. As used herein, low VOC or substantially free of VOCs means less than about 50 g/L in other approaches, less than about 10 g/L, in yet other approaches, less than about 5 g/L, and in yet other approaches, no VOCs.

As used herein, without the need for, without substantial levels of, in the absence of, or substantially free of, substantially none, substantially no, or free-of generally means (unless apparent from the context of the discussion) the coating compositions herein have less than about 1 weight percent, in other approaches, less than about 0.5 weight percent, in other approaches, less than about 0.2 weight percent, and in yet other approaches, none of the particular component or additive. As used herein, essentially free of means no intentionally added amount of an identified material.

When referring to a polymer, oligomer, or copolymer, and a particular monomer or reactant is described, it is also intended that such discussion refers to the resulting monomer unit or associated repeating unit when polymerized within the polymer, oligomer, or copolymer. Likewise, when a monomer unit or repeating unit of a polymer, oligomer, or copolymer is described, the corresponding monomer or reactant is also contemplated by this disclosure. As used herein, the, terms polymer or copolymer are interchangeable unless the context of discussion suggests otherwise. A polymer or copolymer typically have a weight average molecular weight above about 40,000 and an oligomer typically has a molecular weight below 500.

As used herein, (meth)acrylate monomer(s) or monomer unit(s) include both acrylate monomer(s) and monomer unit(s) and methacrylate monomer(s) and monomer unit(s) as well as functionalized (meth)acrylate monomer(s) or monomer unit(s) suitable for incorporation into the functionalized polymers or oligomers disclosed herein. Functional moieties may also bear other crosslinking groups, photo-reactive groups, anti-fouling agents, light absorbers, anti-corrosion agents, and the like as needed for a particular application or use.

As used herein, functionalized, functionality, or functional group means a group or moiety of a larger molecule or polymer reactive with another group or atom.

Opacity or hiding (in some approaches) generally refers to the ability of a film to scatter light based on the thickness of the film. The Opacity is often expressed as S/mil and may be in the form of Kubelka-Munk scattering coefficients as determined using a modification of ASTM D 2805-70 as described in J. E. Mchutt and H. L. Ramsay in American Paint and Coatings Journal, April, 1988, p. 46 by the weight drawdown method, which is incorporated herein by reference.

Sheen may also sometimes be referred to as gloss. In a coating, a gloss finish indicates that the surface which has a coating applied to it (i.e., is finished) it is shiny or glass-like. The gloss of a surface is described as the reflection of light from the surface that is independent of color. ASTM D523 may be used to measure sheen. The prescribed angle at which light is reflected off the surface may vary, but for the purposes of this disclosure to measure 85 Sheen, is measured at 85° relative to the surface reflecting the light. ASTM D523 may also be used to describe 60 Gloss, which is measured at 60° relative to the surface reflecting the light. Gloss may also refer to the gloss intensity measured at 20, 60, or 85 degrees and is determined according to ASTM D323. One of skill in the art is able to determine relative levels of gloss (low versus high) in context of each coating.

A coating refers to any decorative or protective layer formed by applying a thin film of a coating composition to a substrate. Coating compositions include any paint, stain, laquers, etc. A coating composition may contain a solvent (which can include a volatile component derived from a petroleum distillate for a solvent-based paint, or a low VOC, or no-VOC, or water for a water-based paint or composition), a binder polymer, and optionally, a pigment, fillers (such as an extender or a plurality of extenders of different sizes) and one or more additives, which may impart different functionality to the paint or final coating.

A paint refers to a coating composition including pigment and film-forming hinder that, when applied to form a thin (e.g., approximately 100 μm) wet thickness coating film on a freshly-sanded smooth wood surface will, when dried, hide or substantially hide the wood grain and will present a new surface with its own appearance.

Pigment volume concentration or PVC refers to a number that represents the volume of pigment compared to the volume of all solids. In the field of paints and coatings, PVC is a useful measure because the binder (non-pigment) acts as the material to unite all the pigment and other raw materials into the paint and the PVC value ensures there is enough binder to enable the paint or coating to adhere properly to whatever it has been applied over in addition to containing all of the other components of the paint or coating. If a paint or coating has no pigment at all, it will usually be very glossy and have a PVC of zero. An example is clear gloss paints. Flat paints commonly have a very high pigment loading and have high PVCs (usually in the range from about 55% up to about 80%). Another non-limiting exemplary range of PVC in which pigment can be loaded is from about 60% to about 75%. Primers and undercoats vary from 30% to about 50% PVC as do semi-gloss, satin, and low sheen paints. Additionally, it is thought that the lower the PVC of a paint is, the better its mechanical properties (such as tensile strength, and consequently, exterior durability) will be. PVC may be expressed as a percentage. For example, if a coating has a PVC of 30, then 30% of the total binder/pigment blend is pigment, and 70% is binder solids on a volume basis.

Critical pigment volume concentration or CPVC is the point at which there is just enough binder to wet (entirely surround) the pigment particles. As PVC reaches and then increases above CPVC, mechanical properties of the paint or coating deteriorate. Above CPVC, with insufficient binder to satisfy pigment surface and Fill interstitial spaces, air is introduced into the film resulting in a decrease in film integrity. However, above CPVC, increased air and pigment interface results in a substantial boost in pigment scattering efficiency. A film below the CPVC has excess resin and may exhibit a smooth surface that reflects light or appears to be glossy. As the PVC of a film approaches CPVC, the film will appear to be flatter, although the aforementioned loss of mechanical properties may become a limiting factor in how close to CPVC a paint producer wishes to provide the PVC.

Burnish refers to the ability of a coating to retain its gloss value after being subjected to mechanical forces, such as abrasion. Burnish may be measured through ASTM D6736-08.

Refractive Index refers to a measurement that describes how light propagates through a material or medium. If needed, refractive index may be measured through one or more of ASTM D1218, D1747, or D542.

Contrast Ratio is calculated as Y_{black}/Y_{white} and is the ratio of the reflectance of a film on a black substrate to that of an identical film on a white substrate. ASTM D2805-11 provides for the measurement of contrast ratio. Y_{black} represents the reflectance value of a coating and measures the ability of a coating to cover against a black background. Y_{white} represents the reflectance value of a coating and measures the ability of a coating to reflect light against a white background.

Scrub or scrub resistance refers to the ability of the surface of a coating film or paint film to resist being worn away or to maintain its original appearance when rubbed with or against an abrasive surface, typically during cleaning. Scrub resistance can be evaluated through ASTM D2486-96 (Standard Test Method for Scrub Resistance of Wall Paints).

Washability refers to the relative ease of removing dirt, soil, discolorations, and the like, from a dried film applied to a substrate surface, typically an interior architectural surface such as a walk for example. The soil or dirt is typically removed by washing with abrasive and/or non-abrasive cleaning compositions. To measure washability, a standard test method, ASTM D3450-00 (Standard Test Method for Washability Properties of Interior Architectural Coatings) is used. The terms washability and stain resistance are used interchangeably herein.

Chemical resistance as measured herein is determined through ASTM D1308-02 (2013) relating to the chemical resistance of finishes. Chemical resistance tests performed herein were accomplished by following ASTM D1:308 02 (2013) and reporting a rating for each substance tested on a scale of 1 to 5. The following six substances were used for each coating tested: Organic solvents—(1) ethanol, (2) Brake fluid, (3) methyl ethyl ketone (“MEK”); Base—(4) 25% aqueous sodium hydroxide (NaOH); Acids—(5) 10% aqueous acetic acid, and (6) 30% aqueous hydrochloric acid (HO). The following rating scale was used to assign a rating 1 to 5 based on appearance of a coating applied to a substrate after exposure to a particular chemical, 1 indicating the worst performance and 5 the best: 1—substrate visible, 2—severe color change, rust, blistering, delamination, very soft, 3—slight to moderate blistering, delamination and/or wrinkling, loss of gloss, color change, or slightly soft, 4—very slight change in color and gloss at close inspection but seemingly no change at arm's length, 5—no apparent change in color and gloss, no change in film appearance at dose inspection. A coating was ascribed a “good” chemical resistance rating where the sum of the test scores totaled 25 to 30.

Unless the context suggests otherwise and as used herein, “polymer” and “copolymer” refer to molecule that includes a large number of similar units banded together with covalent bonds. The terms “polymer” and “copolymer” are interchangeable and may refer to a homopolymer that is formed from repeating units of one structural unit or monomer as well as a copolymer that may be formed from different types of structural units or monomers.

As used herein, the term “monomers” generally refers to the compound within the reaction mixture prior to polymerization and monomer units or (alternatively) repeating units refers to the monomer as polymerized within the polymeric backbone. The various monomers herein are randomly polymerized within the backbone as the monomer units or repeating units. If the discussion refers to a monomer, it also implies the resultant monomer unit thereof in the polymer. Likewise, if the discussion refers to a monomer unit or repeating unit, it also implies the monomer mixture used to form the polymer with the associated monomer or repeating units therein. As used herein, “(meth)acrylate” refers to both methacrylate and/or acrylate monomers or monomer units (or mixtures) as needed for an application.

As used herein, the terms “applied” or “disposed on” generally mean directly or indirectly in contact with a substrate or surface. These terms include directly in contact with or in contact with another layer or coating that is itself in direct contact with the substrate. “Applied” or “disposed on” may also encompass use of a coating herein as a primer in direct contact with a substrate, a coating herein in direct contact with a substrate without a primer, or a coating on a primer on a substrate. It can also encompass a coating in direct contact with two substrates.

Certain terminology is used herein for convenience only and is not to be taken as a limitation on the present disclosure.

### EXAMPLES

The following examples demonstrate the preparation of copolymers and waterborne compositions such as those described herein above, as well as non-inventive examples for comparison. The examples are intended to be representative of the polymers that can be made and are not intended to limit the scope of the present disclosure to the specific illustrative examples disclosed below. All percentages, ratios, and amounts in this disclosure and the Examples are by weight unless the context of discussion herein suggests otherwise.

### Example 1

Synthesis of a teat-butyldimethylsilylether (TBDMS)-protected catechol monomer (monomer M) was completed as follows: First, 3-(3,4-bis((tert-butyldimethylsily)oxy) phenyl)propanoic acid (compound B) was prepared as follows: to a 250 mL two-neck round bottom flask equipped with magnetic stir bar, 3-(3,4-dihydoxyphenyl) propanoic acid was added (15.0 g, 82.3 mmol). The round bottom flask was then connected to a Schlenk line and an addition funnel. The sealed reaction chamber was subjected to three alternate cycles of vacuum and nitrogen to remove oxygen and moisture. About 50 mL of anhydrous DMF was added and the reaction mixture was homogenized at about 0° C. for about 10 min. To the cooled reaction chamber under nitrogen, imidazole was added (25.2 g, 370.5 mmol, 4.5 eq.) and reacted for about 15 min. Afterward, a solution of about 30 wt/vol % tert-butyldimethylsilyl chloride (TBDMS-Cl, 40.95 g, 271.7 mmol, 3.3 eq.) in DMF was added to the reaction mixture under nitrogen dropwise (addition rate was about 2 drop/s), The reaction was stirred at about 0° C. for about 1 hour and then room temperature (about 25° C.) for about 8 hours. Upon completion of the reaction, the DMF was removed under reduced pressure. About 500 mL of 0.1 NHCl was added to the crude product, and the organic layer was extracted using DCM. The residual water in the organic layer was removed using Na₂SO₄. The organic layer was then combined and concentrated under reduced pressure to obtain tert-butyldimethylsilyl3-(3,4-bis((tert-butyldimethylsilypoxy)phenyl)propanoate (compound).

To a 200 mL one neck round bottom flask containing about 42.89 grams of compound A from above, about 80 mL of MeOH and about 80 mL THE were added. To this homogenous solution K₂CO₃ (22.59 g, 163.42 mmol, 2 eq.) was added. The mixture was stirred at room temperature for about 8 hours. Upon completion of the reaction, the K₂CO₃ was filtered out and the solvents were removed under reduced pressure. After removing MeOH and THF, about 500 mL of 0.1 N Ha was added to the crude product, and the organic compounds were extracted using DCM. The combined organic layers were concentrated under reduced pressure. Column chromatography (ethyl acetate:hexane) was used for obtaining pure product, 3-(3,4-bis((tert-butyldimethylsilyl)oxy)phenyl) propanoic acid (compound B). A quantitative conversion was obtained for the reaction (yield was about 94%).

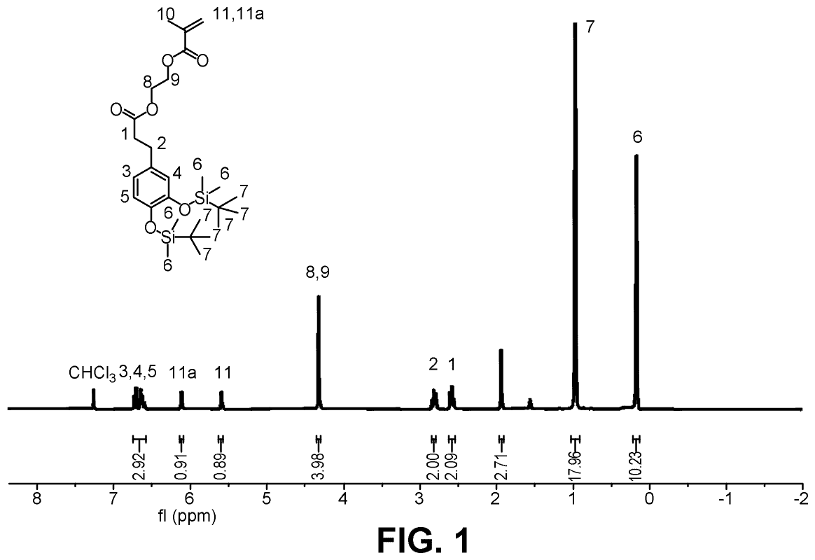

Synthesis of 2-((3-(3,4-bis((tert-butyldimethylsilyl)oxy)phenyl)propanoyl)oxy)ethyl methacrylate (Compound M) was as follows: To a 250 mL one neck round bottom flask, compound B (31.86 g, 77.57 mmol), 2-hydroxyethyl methacrylate (HEMA, 12.11 g, 93.09 mmol, 1.2 eq.), and 4-Dimethylaminopyridine (DMAP, 0.95 g, 7.75 mmol, 0.1 eq.) were added. The reaction chamber was then connected to a Schlenk line. After three alternate cycles of vacuum and nitrogen, about 100 mL of anhydrous DCM was added to the reaction chamber and the mixture was cooled to about 0° C. After about 15 min, N,N′-diisopropyl carbodiimide (DIC, 15.9 mL, 100.85 mmol, 1.3 eq.) was added to the reaction mixture drop-wise with a plastic syringe. The reaction mixture was stirred at room temperature for about 24 hours. Upon completion of the reaction, precipitates were filtered out. The reaction mixture was concentrated under reduced pressure and purified using column chromatography (ethylacetate:hexane). The obtained product (compound M) was a colorless liquid with a yield of about 70%. The compound M was characterized using NMR as shown in FIG. 1.

An exemplary reaction to produce compound M of this Example is shown by Reaction Scheme I below:

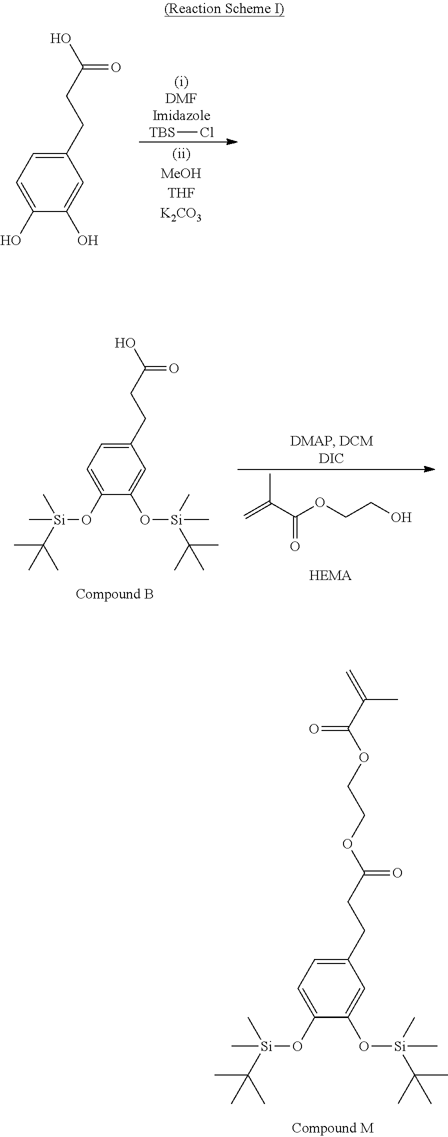

### Example 2

The synthesis of a catechol-protected emulsion polymer including monomer M from Example I was completed as follows: First, a pre-emulsion was prepared: to about 359.71 g of water, sodium dodecyl sulfate (SDS, 5.18 g), NaHCO₃ (2.70 g), and Lutensol® TDA-10 (5.18 g) were added in the given order and dissolved completely. Next, this solution was stirred at about 500 rpm and a monomer mixture of n-butylacrylate (BA, 133.78 g) and tert-butylmethacrylate (tBMA, 128.64 gms) was first mixed and then added dropwise over about 40 min. Following this addition, the remaining monomers of 2-ethylhexylacrylate (EHA, 87.47 g), methylmethacrylate (MMA, 128.64 g), 3-(acryloyloxy)propanoic acid (CEA, 20.58 g), and compound M (15.44 gms) were mixed and added over the next 40 min. The formed pre-emulsion was kept stirring for the next 30 min before transferring to the reactor for polymerization.

Polymerization was carried out under monomer starved conditions at about 82° C. and about 350 stirrer rpm. Continuous addition of the pre-emulsion was added to the stirred reactor over about 2 hours along with steady incorporation of the initiator solution (about 0.45 g ammonium persulfate and 17.99 g water). Post-completion of the pre-emulsion. addition, the reactor was held at temperature for the next 20 min followed by cooling to about 75° C. for the addition of the redox step. The redox components (tBHP and sodium metabisulfite) were added dropwise and given 20 min to completely react. The reactor was then slowly cooled to room temperature over 45 min, followed by filtration and storage of the product.

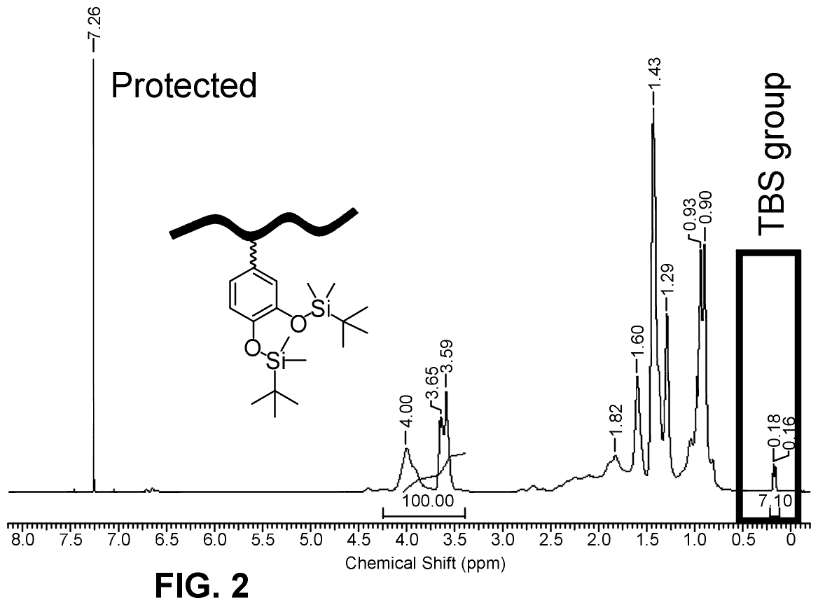

The emulsion polymer was characterized by ¹H NMR and found no trace of unreacted monomer as shown in FIG. 2. The final emulsion size was tested to be about 280 am (0.089 PDI) using Malvern Zetasizer. The solid content was found to be 37.1% (38% theoretical) and the Tg of the material was found to be 14.7° C.

### Example 3

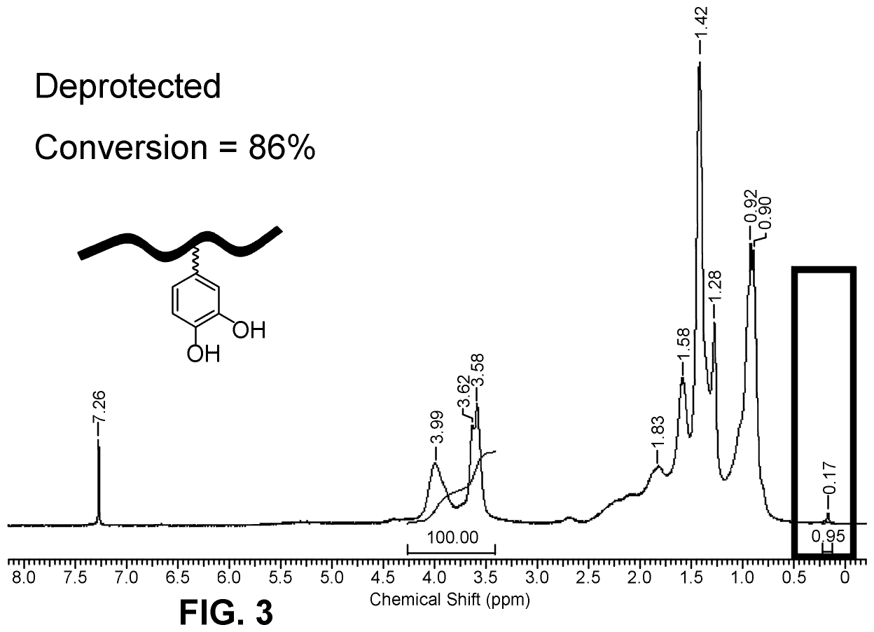

Deprotection of the TBDMS groups from the emulsion polymer of Example 2 occurred as follows: to a 100 mL round bottom flask, about 1.0 g zinc tetrafluoroborate (ZnBF₄) and about 2 mL of water were added. To this solution, about 25 mL of the protected emulsion polymer of Example 2 was added, and the reaction mixture was bubbled with nitrogen for about 10 min. The closed reaction chamber was then heated to about 70° C. for about 24 hours. Upon completion of the reaction, the TBDMS groups were deprotected (about 86% conversion) as shown in FIG. 3.

Unless otherwise specified, all measurements herein are made at 23±1° C. and 50% relative humidity. The dimensions and values disclosed herein are not to be understood as being strictly limited to the exact numerical values recited. Instead, unless otherwise specified, such as dimension is intended to mean both the recited value and a functionally equivalent range surrounding that value. All ranges noted are intended to mean any endpoint within that range. For example, a dimension disclosed as “40 mm” is intended to mean “about 40 mm”.

Illustrative embodiments have been described, hereinabove. It will be apparent to those skilled in the art that the above compositions and methods may incorporate changes and modifications without departing from the general scope of this disclosure. It is intended to include all such modifications and alterations within the scope of the present disclosure. Furthermore, to the extent that the term “includes” is used in either the detailed description or the claims, such term is intended to be inclusive in a manner similar to the term “comprising” as “comprising” is interpreted when employed as a transitional word in a claim.

It is noted that, as used in this specification and the appended claims, the singular forms “a,” “an,” and “the,” include plural referents unless expressly and unequivocally limited to one referent. Thus, for example, reference to “an antioxidant” includes two or more different antioxidants. As used herein, the term “include” and its grammatical variants are intended to be non-limiting, such that recitation of items in a list is not to the exclusion of other like items that can be substituted or added to the listed items

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is to be understood that each component, compound, substituent or parameter disclosed herein is to be interpreted as being disclosed for use alone or in combination with one or more of each and every other component, compound, substituent or parameter disclosed herein.

It is further understood that each range disclosed herein is to be interpreted as a disclosure of each specific value within the disclosed range that has the same number of significant digits. Thus, for example, a range from 1 to 4 is to be interpreted as an express disclosure of the values 1, 2, 3 and 4 as well as any range of such values.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range. That is, it is also further understood that any range between the endpoint values within the broad range is also discussed herein. Thus, a range from 1 to 4 also means a range from I to 3, 1 to 2, 2 to 4, 2 to 3, and so forth.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

1. A polymer prepared through emulsion polymerization, the emulsion polymer comprising:
a backbone having one or more monomer units derived from ethylenically unsaturated monomers including alkyl(meth)acrylate, styrene, (meth)acrylic acid, vinyl acetate, vinyl esters, hydroxyalkyl (meth)acrylate, or combinations thereof;
one or more monomer units functionalized with a dihydroxyphenyl group pendent to the backbone of the emulsion polymer; and
wherein the emulsion polymer is a water-based emulsion polymer.

2. The emulsion polymer of claim 1, wherein the emulsion polymer has a number average molecular weight of about 50,000 to about 1,000,000.

3. The emulsion polymer of claim 1, wherein the dihydroxyphenyl group is a phenyl group having hydroxyl groups that are bonded to adjacent carbon atoms on a benzene ring.

4. The emulsion polymer of claim 1, wherein the dihydroxyphenyl groups include one of a 2,3-dihydroxyphenyl group or a 3,4-dihydroxyphenyl group, or combinations thereof.

5. The emulsion polymer of any preceding claim 1, wherein the emulsion polymer includes about 2 to about 50 weight percent of monomer units functionalized with a dihydroxyphenyl group.

6. The emulsion polymer of claim 1, wherein the emulsion polymer includes about 1 to about 95 weight percent monomer units derived from alkyl(meth)acrylate, about 10 to about 70 weight percent monomer units derived from styrene or alkyl styrene, and/or about 65 to about 90 weight percent monomer units derived from vinyl acetate.

7. The emulsion polymer of claim 1, wherein the emulsion polymer includes about 10 to about 50 weight percent monomer units derived from 2-ethyl hexyl acrylate.

8. The emulsion polymer of claim 1, wherein the emulsion polymer includes about 30 to about 60 weight percent monomer units derived from butyl acrylate.

9. (canceled)

10. (canceled)

11. (canceled)

12. (canceled)

13. (canceled)

14. (canceled)

15. The emulsion polymer of claim 1, wherein the one or more monomer units functionalized with dihydroxyphenyl groups include a meth(acrylate) or vinyl acetate.

16. (canceled)

17. (canceled)

18. (canceled)

19. (canceled)

20. The emulsion polymer of claim 1, wherein the emulsion polymer has a glass transition temperature of about 10° C. to about 100° C.

21. (canceled)

22. (canceled)

23. The emulsion polymer of claim 1, wherein the percent solids of the emulsion polymer based on a total weight of emulsion is from about 30 percent to 70 percent.

24. A waterborne coating composition comprising an aqueous carrier and the water-based emulsion polymer of claim 1.

25. The waterborne coating composition of claim 24, further including one or more of a pigment, a surfactant, an extender particle, a defoamer, a biocide, or combinations thereof.

26. (canceled)

27. The waterborne coating composition of claim 24, wherein the waterborne coating composition has less than about 50 g/L VOCs.

28. (canceled)

29. (canceled)

30. (canceled)

31. (canceled)

32. (canceled)

33. (canceled)

34. A method for producing an emulsion polymer, the method comprising:
polymerizing one or more ethylenically unsaturated monomers in an aqueous solution to form an emulsion polymer, wherein the emulsion polymer includes a protected residue of a catechol group; and
reacting the emulsion polymer containing protected catechol groups with one or more reactants to deprotect the catechol group forming an emulsion polymer having one or more monomer units with the pendant group of structure A 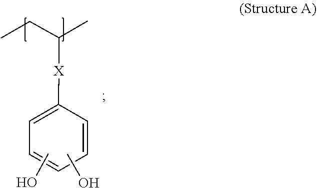
and
wherein X is a bivalent linking group including ester linkages, diester linkages, ether linkages, alkyl linkages, aryl linkages, amino linkages, amide linkages, or combinations thereof.

35. A method for producing an emulsion polymer, the method comprising:
reacting in an aqueous solution a silyl-protected compound comprising (meth)acrylate, styrene, or acetate monomer, or combinations thereof and disilyl ether phenolic groups, with a fluoride ion, acid, or base to yield a water-based emulsion polymer having dihydroxyphenyl groups pendent to a linear or branched backbone of the polymer;
wherein the dihydroxyphenyl groups pendent to the linear or branched polymer backbone have the structure of Formula A: 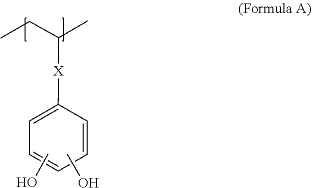
wherein X is a bivalent linking group including ester linkages, diester linkages, ether linkages, alkyl linkages, aryl linkages, amino linkages, amide linkages, or combinations thereof.

36. The method of claim 35, wherein the silyl-protected compound is derived at least in part from reaction of a dihydroxyphenyl alkanoic acid with a trialkyl silyl halide, silyl triflate, or silyl cyanide.

37. The method of claim 35, wherein the silyl-protected compound is further derived at least in part from reaction of an ethylenically unsaturated compound comprising (meth)acrylate, styrene, or acetate structural units.

38. The method of claim 35, wherein the fluoride ion is provided by a zinc compound, a tributyl ammonium fluoride compound, a sodium compound, or a potassium compound.

39. (canceled)

40. (canceled)

41. (canceled)

42. The method of claim 36, wherein the trialkyl silyl halide is a halide salt of tert-butyldimethylsilane (TBDMS) or a halide salt of trimethyl silane (TMS).

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)
